(19) United States
(12) Patent Application Publication
(10) Pub. No.: US 2003/0063784 A1
(43) Pub. Date: Apr. 3, 2003

(54) Method, apparatus, program and recording media for displaying medical image

(75) Inventor: Youichi Ono, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/109,295

(22) Filed: Mar. 28, 2002

(30) Foreign Application Priority Data
Apr. 5, 2001 (JP) 106985/2001
Feb. 25, 2002 (JP) 047659/2002

(51) Int. Cl. G06K 9/00

(52) U.S. Cl. 382/128

(57) ABSTRACT

A method of displaying a medical image, comprises the steps of, (1) processing a image data of the medical image to transform the gradation of the medical image on the basis of the specified output gradation characteristic of an image outputting apparatus for outputting the medical image as a hard copy, and the specified condition of an observation environment in which the hard copy is observed, and (2) displaying the medical image whose gradation has been transformed.

### BACKGROUND OF THE INVENTION

This invention relates to a method of displaying a medical-use image (hereinafter referred to as a medical image), a device for displaying a medical image , a program for displaying a medical image , and a recording medium, in which it is taken into consideration, when a medical image is displayed on an image display device, while it is formed on a film as a hard copy, on the basis of monochromatic image data for medical use.

In the field of medical service, various kinds of radiographing apparatus of a medical image utilizing radiation rays such as X-rays are used. For a medical image pickup apparatus of this kind, an X-ray radiographing apparatus, an RI (Radio Isotope) apparatus, a CR (Computed Radiography) apparatus, a CT (Computed Tomography) apparatus, an ultrasonic wave photographing apparatus, an MRI (Magnetic Resonance Imaging) apparatus are available.

Further, image data obtained by these image pickup apparatus, after being subjected to various kinds of image processing such as frequency processing and gradation processing, are outputted as a hard copy of an image formed on a film, or displayed on an image display device, to be utilized in diagnoses such as checking whether a focus or a lesion is present or not and grasping its content.

For an image display device which is used in a medical image system for image pickup and display, a color image display device may be used, because there exists mixed a system that displays an image monochromatically like a CT image in most cases, and a system that displays a color image like an MRI image in most cases. Further, there are cases where a color image is displayed in color, and a monochromatic image is displayed monochromatically.

Incidentally, there are some cases where an image is formed on a film to be outputted as a hard copy, while a monochromatic image for medical use is displayed on an image display device, on the basis of monochromatic medical image data obtained by an X-ray radiographing apparatus or the like.

Further, this hard copy is one to be observed by a medical doctor etc. in a situation where it is illuminated by a light-box.

### THE FIRST PROBLEM

In such a case, it is necessary that the way an image of a hard copy appears on a light box agrees with the way it appears on a display device. For that reason, it has already been proposed a method in which image data of a medical image are outputted to an image outputting apparatus as perceptually linearized pixel values. However, because this method can be employed only in an image outputting apparatus to which this method is adaptable, and is not adaptable to a conventional (existing) image outputting apparatus, it has been impossible to make the two ways of an image appearing agree with each other owing to the difference in gradation. Hence, there have been cases where a print as expected cannot be obtained when making print after confirming with an image display device. In these cases, another print is made after readjusting the image on the image display device, this caused a loss of output print.

Further, since it has been impossible to make agree with an image appearing by a general image outputting apparatus and a general display device, in order to diagnose a medical image both an image outputting apparatus and an image display device may have been used, or instead of observing the film image outputted from the image outputting apparatus, observing the display image on the image display device may have been done. In these cases, there has been a problem that an exact diagnosis may not be performed.

It is an object of this invention to actualize visual consistency in how an image appears for the two cases of a hard copy and an image display device, even in the case where a conventional (existing) image outputting apparatus, in which the relation between input pixel values and image density levels is specified, is used.

### THE SECOND PROBLEM

Further, as regards image outputting apparatus in which the relation between pixel values and density levels is specified in a fixed state, in order to make a plurality of image outputting apparatus being in states of different output gradation characteristics respectively output a hard copy having an intended gradation characteristic, it is necessary to change the gradation processing of image data to be displayed on an image display device, on the basis of the respective output gradation characteristics of these image outputting apparatus.

It is another object of this invention to get rid of the trouble of resetting the output gradation characteristic of a hard copy for each of image outputting apparatus having different output characteristics respectively.

### THE THIRD PROBLEM

Further, the way a hard copy appears varies in accordance with the environment of observation (the luminance of the light-box, the luminance on the film surface, etc.). Therefore, in a large hospital, which has a plurality of different environments of observation, the way a hard copy appears does not become one to be intended, unless the gradation processing in outputting an image to a film is varied for each of the environments of observation.

It is another object of this invention to get rid of the trouble of resetting the information on the condition of an environment of observation (the luminance of the light-box, the luminance on the film surface, etc.) for each of the environments of observation.

### SUMMARY OF THE INVENTION

The above-mentioned problems can be solved by any one of the structures of this invention described below.

(1) A method of displaying a medical image characterized by comprising the steps of;

transforming the gradation of said medical image on the basis of the specified output gradation characteristic of an image outputting apparatus for outputting a medical image as a hard copy, and the specified condition of an environment of observation in which said hard copy is observed, and

displaying said medical image whose gradation has been transformed.

Further, structure (12) is: A medical image display device characterized by comprising

a gradation processing means for transforming the gradation of a medical image on the basis of the specified output gradation characteristic of an image outputting apparatus for outputting said medical image as a hard copy, and the specified condition of an environment of observation in which said hard copy is observed, and

an image display means for displaying said image whose gradation has been transformed.

In these structures of the invention, the gradation of the medical image is transformed on the basis of the specified output gradation characteristic of an image outputting apparatus for outputting a medical image as a hard copy, and the specified condition of an environment of observation in which said hard copy is observed, then, said medical image whose gradation has been transformed is displayed. For example, the gradation of a medical image can be transformed into a gradation by which, with the specified output characteristic of an image outputting apparatus for outputting a medical image as a hard copy, and the specified condition of the environment of observation in which said hard copy is observed determined beforehand, the hard copy outputted under the condition of the specified output gradation characteristic and the perceptual sensitivity under the specified condition of an environment of observation are brought in a linear relation. Further, the gradation of the medical image can be transformed into a gradation by which, the luminance of an image of a hard copy outputted under the condition of the specified output gradation characteristic in the case where it is observed under said specified condition of an environment of observation and the luminance of the image displayed by said display device are brought in a linear relation.

For this reason, even in the case where a conventional (existing) image outputting apparatus, in which the relation between input pixel values and density levels is specified, is used, it is possible to actualize the visual consistency in how an image appears for the two cases of a hard copy and an image display device.

(2) A method of displaying a medical image characterized by comprising the steps of;

memorizing at least one output gradation characteristic of an image outputting apparatus for outputting a medical image as a hard copy and at least one condition of an environment of observation in which said hard copy is observed,

transforming the gradation of said medical image on the basis of a selected condition of environment of observation and a selected output gradation characteristic, and

displaying said medical image whose gradation has been transformed.

Further, structure (13) is: A medical image display device characterized by comprising;

a memory means for memorizing at least one output gradation characteristic of an image outputting apparatus for outputting a medical image as a hard copy and at least one condition of an environment of observation in which said hard copy is observed,

a gradation transforming means for transforming the gradation of said medical image on the basis of a selected condition of an environment of observation and a selected output gradation characteristic, and

an image display means for displaying said medical image whose gradation has been transformed.

In these structures of this invention, it is practiced that at least one output gradation characteristic of an image outputting apparatus for outputting a medical image as a hard copy, and at least one condition of an environment of observation in which said hard copy is observed are memorized, and the gradation of the aforesaid medical image is transformed on the basis of a selected condition of an environment of observation and a selected output gradation characteristic.

Owing to this, it is possible to eliminate the trouble of resetting the gradation characteristic of a hard copy for each of image outputting apparatus having different output gradation characteristics respectively.

(3) A method of displaying a medical image as set forth in the structure (2) characterized by it that the aforesaid conditions of an environment of observation or the aforesaid output gradation characteristic are memorized in a memory means connected to a medical image inputting (generating) apparatus for generating a medical image through a network.

Further, structure (14) is: A medical image display device as set forth in the structure (13) characterized by it that the aforesaid memory means is disposed at a place connected to a medical image inputting apparatus for generating a medical image through a network.

In these structures of this invention, it is practiced that at least one condition of an environment of observation and at least one output gradation characteristic are memorized in a memory means in the above-mentioned structure (2) connected through a network to a medical image inputting apparatus for generating a medical image.

Owing to this, it is possible to eliminate the trouble of resetting the information on the condition of an environment of observation (the luminance of the light-box, the luminance on the film surface, etc.).

(4) A method of displaying a medical image as set forth in any one of the structures (1) to (3) characterized by it that said specified output gradation characteristic or said specified conditions of an environment of observation is correlated with a specified image outputting apparatus beforehand, and the correlated specified output gradation characteristic or the correlated conditions of an environment of observation is applied as the basis of transforming a gradation of a medical image when the specified image outputting apparatus is used.

Further, structure (15) is: A medical image display device as set forth in any one of the structures (12) to (14), characterized by it that said specified output gradation characteristic or said specified conditions of an environment of observation is correlated with an image outputting apparatus beforehand, and the correlated specified output gradation characteristic or the correlated conditions of an environment of observation is applied for transforming a gradation of a medical image when the respective (specified) image outputting apparatus is used.

According to these structures, specified conditions of an environment of observation or specified output gradation characteristic is correlated beforehand with respective image outputting apparatus, therefore it becomes possible that the correlated conditions of an environment of observation or the correlated output gradation characteristic is applied in accordance with the respective image outputting apparatus for transforming the medical image.

Owing to this, it is possible to eliminate the trouble of resetting the information on the condition of an environment of observation (the luminance of the light-box, the luminance on the film surface, etc.), in accordance with the respective conditions of an environment of observation or the output gradation characteristic of medical image outputting apparatus.

(5) A medical image display method as set forth in any one of the structures (1) to (4), characterized by it that the gradation of a medical image is transformed into a gradation, by which the luminance of an image of a hard copy outputted under the condition of the specified output gradation characteristic and observed under the specified condition of an observation environment, and the luminance of a displayed image are brought in a perceptually linear relation.

Further, structure (16) is: A medical image display device as set forth in any one of the structure (12) to (15), characterized in that the gradation of a medical image is transformed into a gradation, by which the luminance of an image of a hard copy outputted under the condition of the specified output gradation characteristic and observed under the specified condition of an observation environment, and the luminance of a displayed image are brought in a perceptually linear relation. (6) A method of displaying a medical image as set forth in any one of the structures (1) to (4) characterized in that the gradation of a medical image is transformed into a gradation, in which the luminance of an image of a hard copy outputted under the condition of the specified output gradation characteristic, in the case where it is observed under said specified condition of an environment of observation, and the luminance of the image displayed by said display device are brought in a linear relation.

Further structure (17) is: The medical image display device as set forth in any one of the structure (12) to (15), characterized in that the gradation of a medical image is transformed into a gradation, in which the luminance of an image of a hard copy outputted under the condition of the specified output gradation characteristic, in the case where it is observed under said specified condition of an environment of observation, and the luminance of the image displayed by said display device are brought in a linear relation.

(7) A method of displaying a medical image as set forth in any one of the structures (1) to (4), characterized by it that the gradation of the aforesaid medical image is transformed into a gradation, by which the lightness obtained in the case where a hard copy of an image outputted under the condition of the aforesaid specified output gradation characteristic is observed under the aforesaid specified condition of an environment of observation, and the lightness of the image displayed on the aforesaid image display device are brought in a linear relation.

Further structure (18) is: The medical image display device as set forth in any one of the structure (12) to (15), characterized in that the gradation of a medical image is transformed into a gradation, by which the lightness obtained in the case where a hard copy of an image outputted under the condition of the aforesaid specified output gradation characteristic is observed under the aforesaid specified condition of an environment of observation, and the lightness of the image displayed on the aforesaid image display device are brought in a linear relation.

(8) A method of displaying a medical image as set forth in any one of the structures (1) to (4), characterized by it that the gradation of the aforesaid medical image is transformed into a gradation, by which the logarithmic values of the luminance obtained in the case where a hard copy of an image outputted under the condition of the aforesaid specified output gradation characteristic is observed under the aforesaid specified condition of an environment of observation, and the logarithmic values of the luminance of the image displayed on the aforesaid image display device are brought in a linear relation.

Further structure (19) is: The medical image display device as set forth in any one of the structure (12) to (15), characterized in that the gradation of a medical image is transformed into a gradation, by which the logarithmic values of the luminance obtained in the case where a hard copy of an image outputted under the condition of the aforesaid specified output gradation characteristic is observed under the aforesaid specified condition of an environment of observation, and the logarithmic values of the luminance of the image displayed on the aforesaid image display device are brought in a linear relation.

(9) A method of displaying a medical image as set forth in any one of the structures (1) to (4), characterized by it that the gradation of the aforesaid medical image is transformed into a gradation, by which the lightness obtained in the case where a hard copy of an image outputted under the condition of the aforesaid specified output gradation characteristic is observed under the aforesaid specified condition of an environment of observation, and the lightness of the image displayed on the aforesaid image display device are made equivalent.

Further structure (20) is: The medical image display device as set forth in any one of the structures (12) to (15), characterized by it that the gradation of the aforesaid medical image is transformed into a gradation, by which the lightness obtained in the case where a hard copy of an image outputted under the condition of the aforesaid specified output gradation characteristic is observed under the aforesaid specified condition of an environment of observation, and the lightness of the image displayed on the aforesaid image display device are made equivalent.

(10) A method of displaying a medical image as set forth in any one of the structures (1) to (4), characterized by it that the gradation of the aforesaid medical image is transformed into a gradation, by which the lightness obtained in the case where a hard copy of an image outputted under the condition of the aforesaid specified output gradation characteristic is observed under the aforesaid specified condition of an environment of observation, and the lightness of the image displayed on the aforesaid image display device are made equivalent, and further, in the case where a region of the gradation transformed by the aforesaid transformation is irreproducible because of the effect of lightness minimum value of the medical image display device, the gradation is corrected so that the irreproducible region can be reproduced.

Further structure (21) is: The medical image display device as set forth in any one of the structures (12) to (15), characterized by it that the gradation of the aforesaid medical image is transformed into a gradation, by which the lightness obtained in the case where a hard copy of an image outputted under the condition of the aforesaid specified output gradation characteristic is observed under the aforesaid specified condition of an environment of observation, and the lightness of the image displayed on the aforesaid image display device are made equivalent, and further, in the case where a region of the gradation transformed by the aforesaid transformation is irreproducible because of the effect of lightness minimum value of the medical image display device, the gradation is corrected so that the irreproducible region can be reproduced.

(11) The method of displaying a medical image as set forth in the structures (10), characterized by it that the gradation transformation of the aforesaid medical image is conducted so that the irreproducible region is made reproducible by applying a smoothing operation to the characteristic curve of the image subjected to the gradation transformation.

Further structure (22) is: The medical image display device as set forth in the structure (21), characterized by it that the gradation transformation of the aforesaid medical image is conducted so that the irreproducible region is made reproducible by applying a smoothing operation to the characteristic curve of the image subjected to the gradation transformation.

(12) Further, also a program for displaying a medical image characterized by actualizing a method of displaying a medical image as set forth in any one of the above-mentioned structures (1) to (11) is a means for solving the problems.

(13) Further, also a recording medium in which a program for displaying a medical image characterized by actualizing a method of displaying a medical image as set forth in any one of the above-mentioned structures (1) to (13) is recorded is a means for solving the problems.

### BRIEF DESCRIPTION OF THE DRAWINGS

FIG. 1 is a functional block diagram showing the structure of a medical image display apparatus of an example of the embodiment of this invention.

FIG. 2(a) to 2(e) are drawings for explanation showing the characteristics in determining the gradation transformation characteristic in an example of the embodiment of this invention.

FIG. 3(a) to 3(e) are drawings for explanation showing the characteristic in determining the gradation transformation characteristic in an example of the embodiment of this invention.

FIG. 4 is a drawing for explanation showing the characteristic in determining the gradation transformation characteristic in an example of the embodiment of this invention.

FIG. 5(a) and 5(b) are drawings for explanation showing the characteristic in determining the gradation transformation characteristic in an example of the embodiment of this invention.

FIG. 6(a) to 6(g) are drawings for explanation showing the characteristic in determining the gradation transformation characteristic in an example of the embodiment of this invention.

FIG. 7 is a drawing for explanation showing the characteristic in determining the gradation transformation characteristic in an example of the embodiment of this invention.

### DETAILED DESCRIPTION OF THE PREFERRED EMBODIMENT

In the following, an example of the embodiment of this invention will be explained in detail with reference to the drawings.

### THE STRUCTURE OF A MEDICAL IMAGE DISPLAY DEVICE

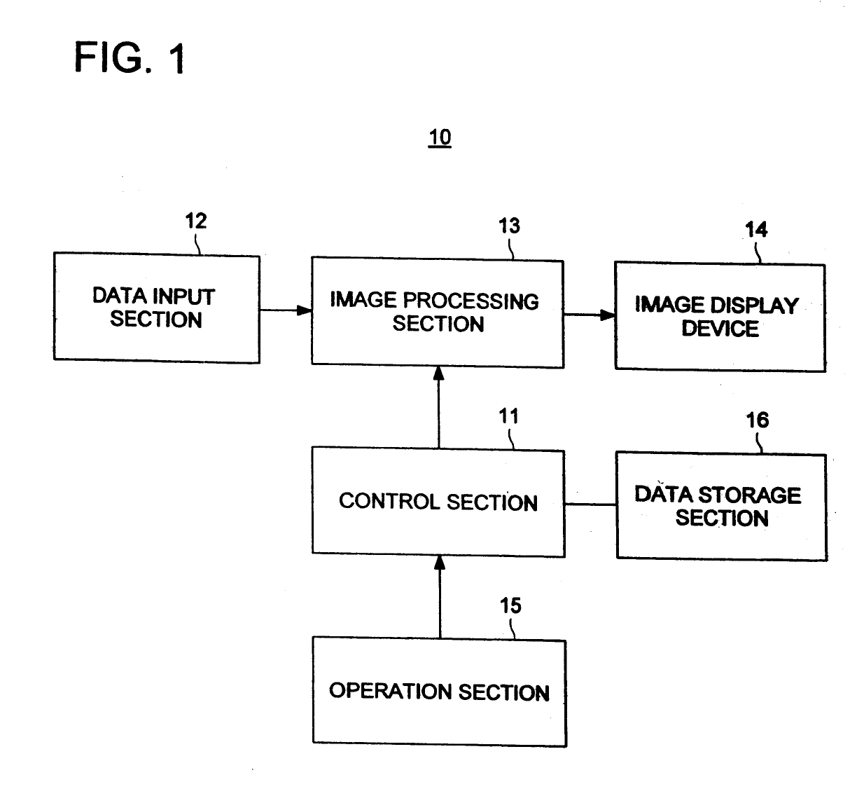

In the following, the structure of a medical image display device 10 will be explained on the basis of FIG. 1, which is a rough functional block diagram.

Notation 11 denotes a control section as a control section for controlling various parts of the medical image display device 10, 12 denotes a data input section (or an image receiving section) to which medical image data are inputted, 13 denotes an image processing section for practicing image processing for display characteristic of this example of the embodiment, 14 denotes an image display device (hereinafter referred to as a monitor) for displaying various kinds of monochromatic or color images for medical use, 15 denotes an operation section where inputting by an operation of a human observer is done, and 16 denotes a data storage section for holding various kinds of set data. Besides, the image processing section 13 is a section, as a gradation processing means in the claims, for making the visual appearance of an image on the image display device agrees with that on a hard copy by practicing gradation transformation by means of an LUT for monitor display to be described later.

As image output apparatus outputting hard copies, for example, there are medical imagers (thermal printing apparatus, silver halide photographic material recording apparatus, etc.), inkjet printer, and the like. Further as the display devices, there are a CRT display device, a liquid crystal display device, a plasma display device, an organic EL display device, and the like.

In this specification, it is supposed that image data for medical use are generated by a medical image pickup apparatus (not shown in the drawing). These image data for medical use are inputted from the data input section 12. In this case, the medical image pickup apparatus (not shown in the drawing) may be connected to the medical image display device 10 through a network, or may carry out the transfer of data through an electronic recording medium.

### THE OPERATION OF THE MEDICAL IMAGE DISPLAY DEVICE

In an environment where the medical image display device 10 of this example of the embodiment works, although it is not shown in the drawing, it is assumed that a hard copy composed of a film having an image formed on it on the basis of image data for medical use is concurrently brought in a state of being observable by a light-box illuminating it. In addition, the outputting of a hard copy by an image outputting apparatus may be done either in the same room or in another room.

Further, as explained already, because the relationship between input pixel values and density values is specified (fixed) in a conventional (existing) image outputting apparatus, as regards the visual appearance of an image on the image display device and that on a hard copy, it has been impossible to make them agree with each other owing to the difference in the gradation. Further, owing to the difference in gradation characteristic of a plurality of image outputting apparatus, and the difference in the environment of observation too, in the same way, as regards the visual appearance of an image on the image display device and that on a hard copy, it has been impossible to make them agree with each other.

In order to solve such problems, the medical image display device 10 practices the following processing to determine the gradation (calculation of the LUT for monitor display). For practicing the processing, the control section 11 and the image processing section 13 operate in accordance with the medical image display program.

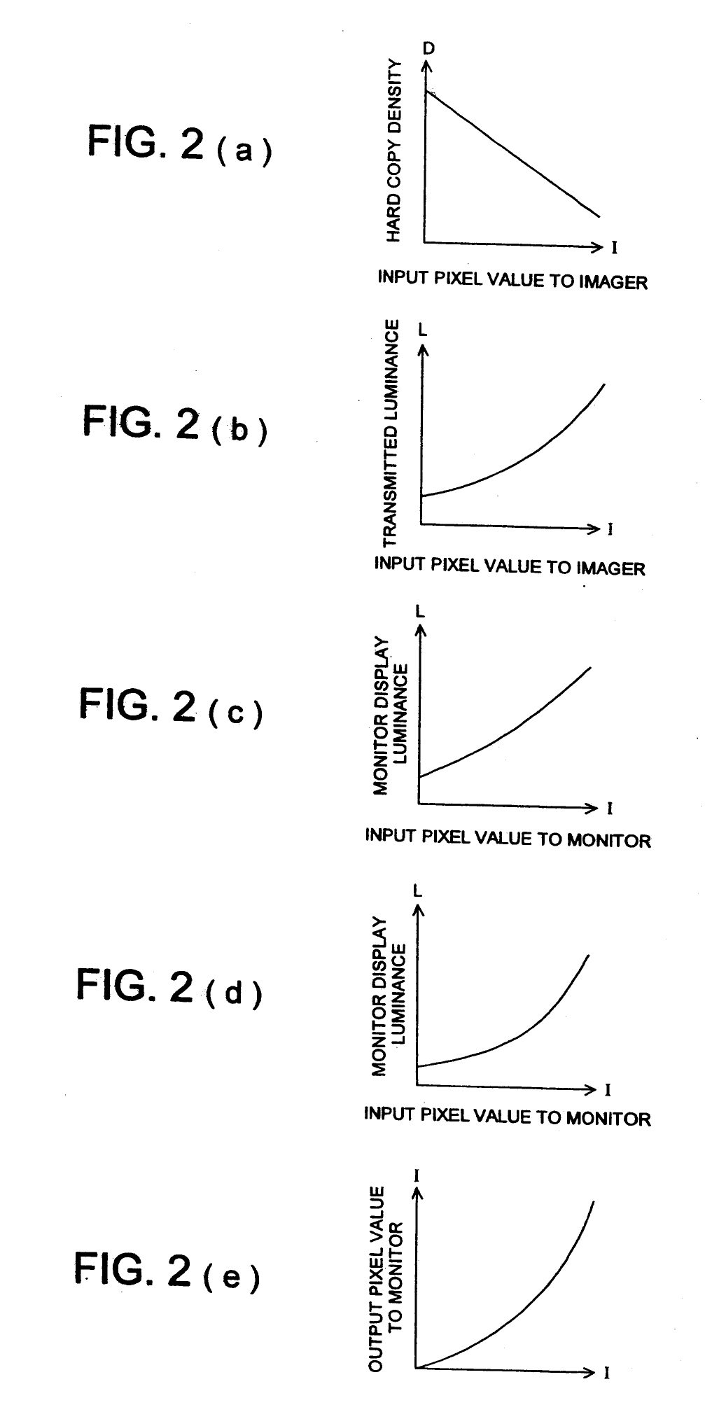

First, the characteristic of a hard copy image outputted from the image outputting apparatus (an imager) (the“output gradation characteristic” showing the relationship between the input to the imager and the hard copy image density D) is represented by FIG. 2(a). Further, in the case where a hard copy is observed with the illumination by a light-box, the luminance L is expressed by the following equation using the luminance of the light emission of the light-box LO and the luminance contribution La due to the room illumination reflected from the surface during the stop of the light emission of the light-box. In addition, the luminance of the light emission of the light-box L0 and the luminance contribution La due to the room illumination reflected from the surface during the stop of the light emission of the light-box represent“the condition of an environment of observation”.

L=La+L0·10^{-D}.

In addition, the form of this luminance L curve is shown in FIG. 2(b).

Further, the above-mentioned specified output gradation characteristic of a hard copy is determined as the “specified output gradation characteristic”, and the specified condition of an environment of observation is determined as the “specified condition of an environment of observation”; these are stored in the data storage section 16 beforehand.

Besides, in the above, the“specified output gradation characteristic” may be any one of a standard output gradation characteristic, an output gradation characteristic whose characteristic values are inputted manually from the operation section or the like, and an output gradation characteristic whose characteristic values are given from an imager through a network.

Further, the “specified condition of an environment of observation” mentioned in the above may be any one of a standard condition of an environment of observation, a condition of an environment of observation whose characteristic values are inputted manually from the operation section or the like, and a condition of an environment of observation whose characteristic values are given from an imager through a network.

Further, also it is appropriate that, as regards the above-mentioned output gradation characteristic of a hard copy, a plurality of output gradation characteristics for each apparatus and a plurality of conditions of an environment of observation for each environment are determined, and are stored in the data storage section 16 beforehand.

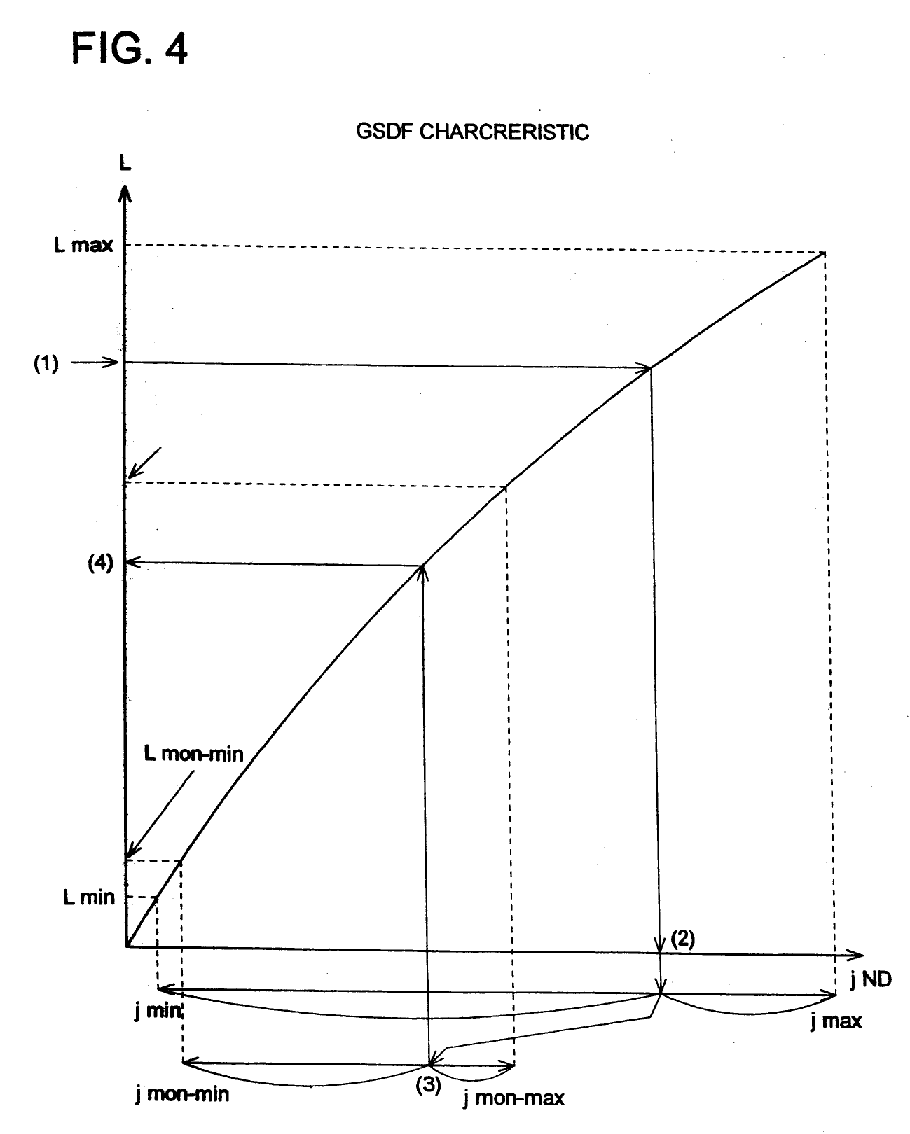

Now, the monitor target gradation characteristic of the monitor 14 (FIG. 2(c)) will be obtained by using the maximum luminance Lₘₒₙ₋ₘₐₓᵢ, which is the maximum value to be displayed by the monitor 14, the minimum luminance Lₘₒₙ₋ₘᵢₙ, and the GSDF (Grayscale Standard Display Function) characteristic (refer to FIG. 4) defined by a standard called DICOM (Digital Imaging and Communications in Medicine).

The GSDF characteristic mentioned in the above is a characteristic curve shown in FIG. 4 as an example, and is one that determines index values corresponding to the luminance difference ΔL just noticeable by a human observer. In this specification, it is defined that Lmax denotes the maximum luminance of a hard copy, Lₘₐₓ, denotes the minimum luminance of a hard copy, Lₘₒₙ₋ₘₐₓ denotes the maximum luminance of the monitor, and Lₘₒₙ-min denotes the minimum luminance of the monitor. Further, it is defined that jₘₐₓ, jₘᵢₙ, jₘₒₙ₋ₘₐₓ, and jₘₒₙ₋ₘᵢₙ denotes the index values corresponding to the above-mentioned luminance values respectively. First, from a certain luminance value (1) of a hard copy, the corresponding imager index value (2) is obtained. Next, from the ratio of the imager index value (2), which is within the range of the minimum to maximum, to the maximum value jₘₐₓ, the monitor index value (3) having the same ratio to the jₘₒₙ₋ₘₐₓ is obtained. Further, the monitor luminance value (4) corresponding to this monitor index value (3) is obtained. This procedure is done for every point of ΔL on the GSDF characteristic curve, to calculate the monitor target gradation characteristic of the monitor 14 (FIG. 2(c)).

Further, by referring to the monitor display gradation characteristic (FIG. 2(d)) showing the display gradation characteristic of the actual monitor 14, it is calculated an LUT for monitor display (FIG. 2(e)) as a look-up table to make it possible to actualize the above-mentioned monitor target gradation characteristic (FIG. 2(c)).

By carrying out image display by the monitor 14 after the practice of gradation transformation processing using the above-mentioned LUT for monitor display (FIG. 2(e)) in the image processing section 13, the same visual appearance of an image with the same gradation characteristic as that on a hard copy illuminated by a light-box can be obtained.

Incidentally, in the above explanation using FIG. 2(a) to 2(e), an example is explained where the larger the input pixel value is the lower the hard copy density becomes, however, the present invention is not limited to this example.

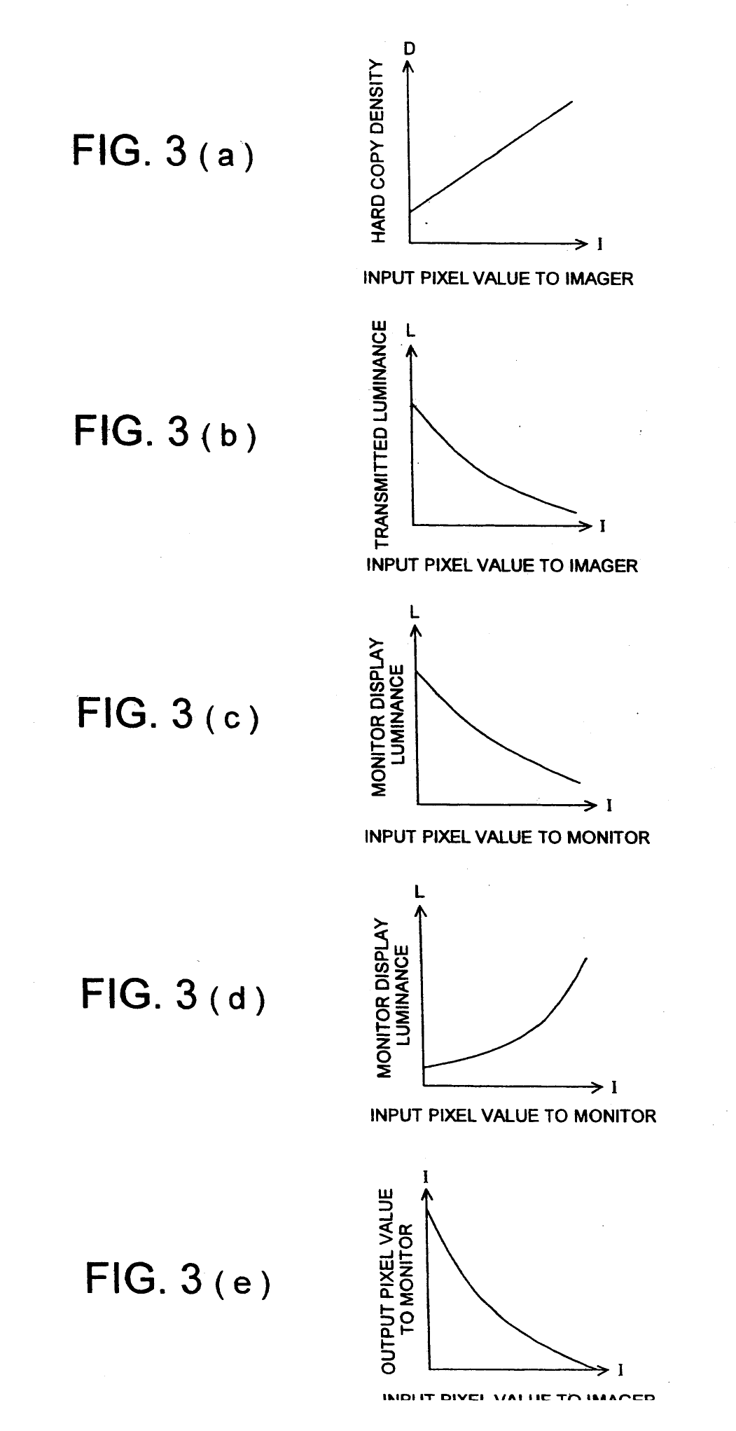

For example, as illustrated in FIG. 3(a) to 3(e), in cases where the larger the input pixel value is the higher the hard copy density becomes, FIG. 3(b), 3(c), and 3(e) become the reversed characteristics to FIG. 2(b), 2(a), and 2(e). Herein, FIG. 2(d) and FIG. 3(d) represent the characteristic of the monitor, and have the same characteristic. Even in these cases, by conducting the image display with the monitor 14 after the image processing section 13 performs gradation transformation using the lookup table (FIG. 3(e)), the appearance of the display can be agree with the gradation characteristic of the hard copy illuminated on the light-box.

Namely, owing to the above mentioned structure and processing, the gradation of a medical image is possible to be transformed into a gradation, by which a hard copy outputted under the condition of the specified output gradation characteristic and the perceptual sensitivity under the specified condition of an environment of observation are brought in a linear relation.

Accordingly, whichever the display with monitor or outputted image on film is used for medical diagnosis, the gradation of both images coincide each other and show the same appearance, therefore, appropriate diagnosis become possible.

### THE OPERATION OF THE MEDICAL IMAGE DISPLAY DEVICE (2)

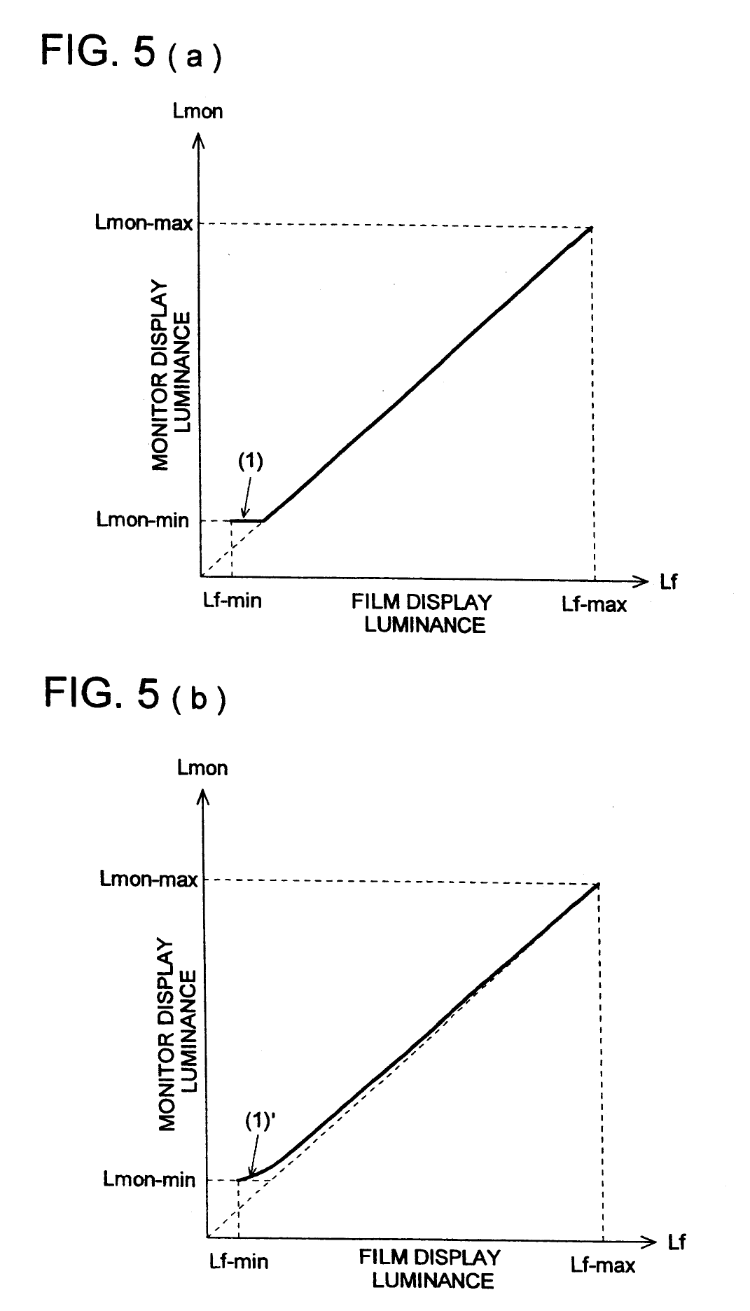

Further, in cases where image display is conducted through the gradation transformation in which the lightness of the hard copy observed and the lightness of display image on the monitor become equivalent, as shown in FIG. 5(a) a straight line is allocated to connect the point of origin and the maximum point of both parameters. And in cases where the gradation transformation to make equivalent lightness is performed, and when the ratio of minimum value to maximum value of monitor display luminance (Lₘₒₙ₋ₘᵢₙ/Lₘₒₙ₋ₘₐₓ) is larger than the ratio of minimum value to maximum value of film display luminance (L_{f-min}/L_{f-max}), a region where the gradation is irreproducible appears as (1) in FIG. 5(a). At the region (1) in FIG. 5(a), a gradation exists on the film, but appears in blocked black on the monitor display.

Hereinafter, gradation badness at the low luminance region of the monitor display and the countermeasure to it will be explained.

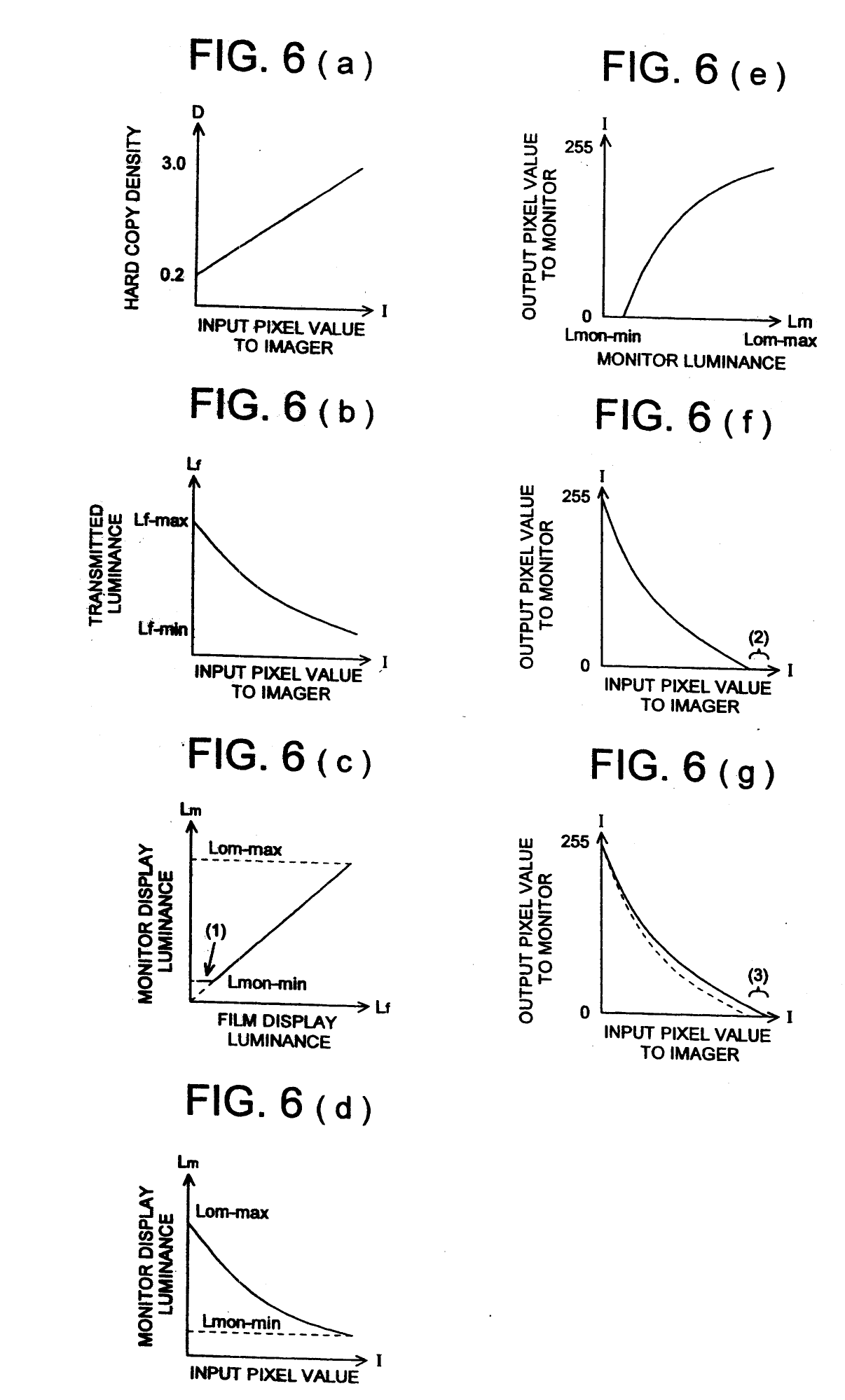

Firstly a characteristic of the hard copy (“output gradation characteristic” representing the relation between imager input and hard copy density) outputted from an image outputting apparatus (imager) is shown in FIG. 6(a) as an example. Further, in the case where a hard copy is observed with the illumination by a light-box, the luminance L determined by the luminance of the light emission of the light-box L₀ and the luminance contribution La due to the room illumination reflected from the surface during the stop of the light emission of the light-box is shown in FIG. 6(b).

Herein, as the characteristic is allocated to a straight line passing through the point of origin in order to perform the gradation transforming processing to attain the lightness equivalent, in cases where the characteristic to make the linear relation between film display luminance and the monitor display luminance is defined as FIG. 6(b), when the ratio of minimum value to maximum value of monitor display luminance (Lₘₒₙ₋ₘᵢₙ/Lₘₒₙ₋ₘₐₓ) is larger than the ratio of minimum value to maximum value of film display luminance (L_{f-min}/ L_{f-max}) a region where the gradation is irreproducible appears as (1) in FIG. 6(a).

Then, a gradation characteristic goal for monitor 14 (FIG. 6(d)) is set so as to attain the characteristic line like the one shown in FIG. 6(a). Further, the relation between the monitor display luminance and output pixel value to the monitor is shown in FIG. 6(e). And LUT for the monitor display (FIG. 6(f)) is calculated as the Look Up Table that can realize the aforementioned gradation characteristic goal for monitor (FIG. 6(d)).

In this LUT of FIG. 6(f), the gradation irreproducible region (FIG. 6(f), (2)) exists in correspondence with the gradation blocking of FIG. 6(C), (1). Hence, in an example of the embodiment of the present invention, it is characterized that in the case where a region of the gradation is irreproducible because of the effect of minimum luminance value of the monitor, the gradation is corrected so that the irreproducible region can be reproduced as shown in FIG. 6(g), (3).

As for this kind of gradation correction processing, for example, there is a method where, in order to make the irreproducible gradation region possible to be reproduced, smoothing processing of the characteristic curve subjected to the gradation transformation is performed repeatedly if necessary.

Herein, the smoothing processing is a processing to substitute a line in vicinity of the connection point of the curved line and the straight line located at the irreproducible region to a smoothly curved line, which makes the gradation reproduction possible.

Further, as for this kind of gradation correction processing, there is another method for example:

A remarked pixel value is denoted as Yᵢ, and factors of a1 to a5 are expressed by the next equation.

a+a2+a3+a4+a5−1

Yᵢ′ is defined as;

Yᵢ′=a1Yᵢ₋₂+a2Y_{i-1 +a}3Yᵢ+a4Yᵢ₊₁+a5Yᵢ₊₂

And a new remarked pixel value Yi can be generated by making a weighted average of pixels in vicinity. In this case, for a quick calculation, calculations of every plural pixels can be done. Herein, both ends of the characteristic curve are left fixed, and remarked pixels in the intermediate region are calculated.

As a result of the abovementioned gradation correction processing, the characteristic curve become like FIG. 6(g), (3), or like FIG. 5(b), (1)′. By this, even in the case where the gradation irreproducible blocking black region exists, caused by the effect of minimum display luminance of the monitor, the irreproducible region is made possible to be reproduced.

The above explanation is for the case where the lightness is made equivalent, and the following is the explanation of the case where the lightness is made linear.

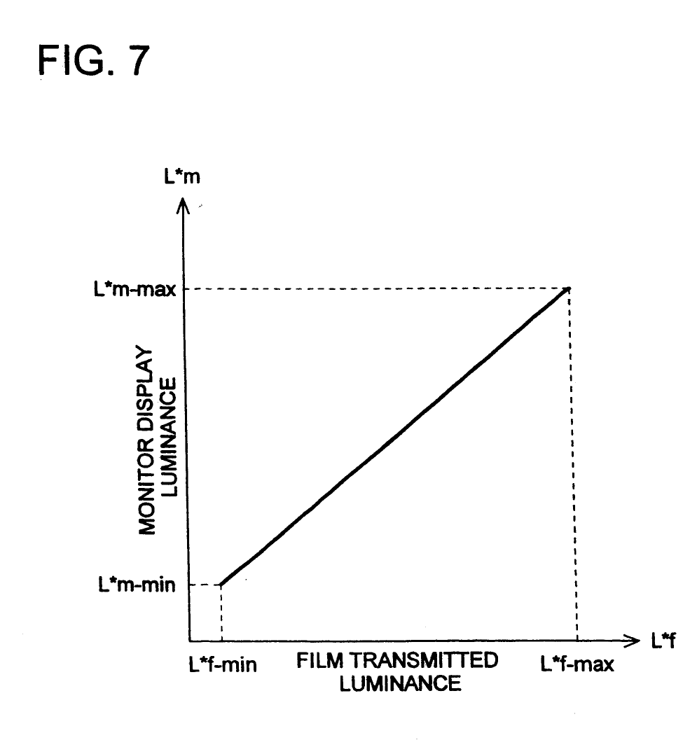

FIG. 7 shows a characteristic of the case where the lightness is made linear, as the other embodiment of the present invention. In this embodiment, the lightness L* is used, and the lightness has a characteristic approximate to the perceptual characteristic of the human eye, therefore it is preferable in spite of necessity of hereafter explained transformation from the luminance to the lightness.

Namely, the lightness L* is expressed as follows, by defining Y as the luminance of the film illuminated by a light-box or the monitor luminance of the image display device 10, and defining Yn as the maximum luminance of the film illuminated by a light-box or the maximum monitor luminance of the image display device 10.

In cases where, Y/Yn>0.008856,

L*=116(Y/Yn)^{1/3}−16,

In cases where, Y/Yn≦0.008856,

L*=903.29(Y/Yn),

Further, for the gradation transformation where the lightness of the hard copy observed under the specified condition of an environment of observation, and the lightness of the image displayed on the monitor are made linear, as shown in FIG. 7, the characteristic line is made by connecting, with straight line, the point of maximum value of film transparent lightness L*f−ₘₐₓ and maximum value of monitor display lightness L*ₘₒₙ₋ₘₐₓ, and the point of minimum value of film transparent lightness L*f-min and minimum value of monitor display lightness L*ₘₒₙ₋ₘᵢₙ. In this case, while not passing through the point of origin, linear characteristic is obtained where the maximum point of both parameters and the minimum point of both parameters are connected by a straight line.

### EFFECTS OF EMBODIMENTS OF THE INVENTION

Further, it is possible that, by determining a standard characteristic out of such output gradation characteristics of a hard copy as mentioned in the above as the specified output gradation characteristic, and also determining a standard condition of an environment of observation as the specified condition of an environment of observation as the default, a standard LUT for monitor display can be obtained by using these standard output gradation characteristic and standard condition of an environment of observation. Hence, even in the case where a conventional image outputting apparatus in which the relationship between input pixel values and density values are specified, it is possible to actualize the visual consistency in how an image appears for the two cases of a hard copy and an image display device.

Moreover, by using an individual characteristic among output gradation characteristics of a hard copy and an individual condition of an environment of observation, an LUT for monitor display can be obtained in accordance with the condition in which actual observation is carried out. By doing this, it can be eliminated the trouble of resetting the output gradation characteristic of a hard copy for each of image outputting apparatus having different output gradation characteristics respectively.

Further, in the above-mentioned example of the embodiment, in the case where the medical image display device 10 is an image system connected to a network, it is possible to dispose the data holding section 16 at any one of places connected to the network. Thus, through storing various kinds of conditions and LUT's for monitor display at the places where outputting and display are carried out, and practicing gradation transformation in accordance with the conditions of the place (room) where the outputting and the display are carried out, a suitable image display adapted to the environment of observation becomes possible. By doing this, it is possible to eliminate the trouble of resetting the condition of an environment of observation (the luminance of the light-box, the luminance on the film surface, etc.) for each environment of observation.

Further, in the same manner, by correlating the condition of the environment of observation or the output gradation characteristics to the image outputting apparatus beforehand, the LUT is formed (or is read out) by applying the correlated conditions of an environment of observation or the correlated output gradation characteristic in accordance with the respective image outputting apparatus to transform the gradation of the image. By this, it becomes possible to eliminate the trouble of resetting the information on the condition of an environment of observation (the luminance of the light-box, the luminance on the film surface, etc.) or output gradation characteristics, in accordance with the respective conditions of an environment of observation or the output gradation characteristic of medical image outputting apparatus.

In this way, by preparing the LUT for the respective image outputting apparatus, preferable effect can be attained in cases where many network connected apparatus or devices are used.

As the result of making up this example of the embodiment in the above-mentioned way, even in a network environment where both a hard copy and a monitor diagnosis are used together, the effect of improving the quality of diagnosis can be obtained.

Further, because how an image on a hard copy appears can be presumed from the monitor display of the image on an image display device, the futility of making a hard copy over again owing to a poor adjustment of gradation transformation can be reduced.

Further, also it is possible to use an image outputting apparatus in such a way as to make it output a hard copy after the desired state of the image display is obtained through watching the monitor display on an image display device.

Further, because the visual appearance of an image on a hard copy can be made to agree with that on a monitor display without changing the condition at the hard copy side, it is obtained the effect that the property of gradation transformation parameter which are optimized for use in making a hard copy is not made useless.

Further, in the case where the state of illumination is delicately different from one light-box to another and whether one or another light-box is desirable or not depends on the human observer, this example of the embodiment is extremely effective, because the output of an image outputting apparatus and the display on an image display device can be simply changed.

Further, in the case where an output desirable for the human observer cannot be produced even by the operation described in the above-mentioned example of the embodiment, it becomes possible to change the output of an image outputting apparatus or the display of an image display device by adjusting the contrast and density on the basis of well known image processing technology.

### OTHER EXAMPLES OF THE EMBODIMENT

Besides, it is also a means for solving the problems and an important part of this invention, a program (a computer program) for displaying a medical image characterized by actualizing the method of displaying a medical image which has been shown in the above-mentioned example of the embodiment. In the same way as the example of the embodiment, it is also a means for solving the problems and an important part of this invention, a recording medium on which a program for displaying a medical image characterized by actualizing the method of displaying a medical image which has been shown in the above-mentioned example of the embodiment.

As explained in detail in the foregoing, in this invention, the gradation of a medical image is transformed into a gradation by which, with the specified output characteristic of an image outputting apparatus for outputting a medical image as a hard copy, and the specified conditions of the environment of observation in which said hard copy is observed determined beforehand, the hard copy outputted under the condition of the specified output gradation characteristic and the perceptual sensitivity under the specified conditions of the environment of observation are brought in a linear relation, or into a gradation by which the luminance of an image of a hard copy outputted under the condition of the specified output gradation characteristic in the case where it is observed under said specified condition of an environment of observation and the luminance of the image displayed by a display device are brought in a linear relation; therefore, even in the case where a conventional image outputting apparatus, in which the relationship between input pixel values and density levels is specified, is used, it cab be actualized the visual consistency in how an image appears for the two cases of a hard copy and an image display device.

What is claimed is:

1. A method of displaying a medical image, comprising the steps of:
processing image data of the medical image to transform the gradation of the medical image on the basis of the specified output gradation characteristic of an image outputting apparatus for outputting the medical image as a hard copy and the specified condition of an observation environment in which the hard copy is observed; and
displaying the medical image based on the processed image data so that the medical image whose gradation has been transformed is displayed.

2. A method of displaying a medical image, comprising the steps of:
memorizing at least one output gradation characteristic of an image outputting apparatus for outputting the medical image as a hard copy and at least one condition of an observation environment in which the hard copy is observed;
selecting an output gradation characteristic and a condition of an observation environment from the memory;
processing an image data of the medical image to transform the gradation of the medical image on the basis of a selected condition of observation environment and a selected output gradation characteristic; and
displaying the medical image based on the processed image data so that the medical image whose gradation has been transformed is displayed.

3. The method of displaying a medical image as recited in claim 2, wherein the condition of an observation environment or the output gradation characteristic are memorized in a memory means connected to a medical image generating apparatus for generating the medical image through a network.

4. The method of displaying a medical image as recited in claim 1, wherein the specified output gradation characteristic or the specified condition of an observation environment is correlated with a specified image outputting apparatus beforehand, and the correlated specified output gradation characteristic or the correlated condition of an observation environment is applied as the basis of transforming the gradation of the medical image when the specified image outputting apparatus is used.

5. The method of displaying a medical image as recited in claim 1, wherein the gradation of the medical image is transformed into such a gradation, by which the luminance of an image of a hard copy outputted under the condition of the specified output gradation characteristic and observed under the specified condition of an observation environment, and the luminance of a displayed image are brought in a perceptually linear relation.

6. The method of displaying a medical image as recited in claim 1, wherein the gradation of a medical image is transformed into such a gradation, by which the luminance of an image of a hard copy outputted under the condition of the specified output gradation characteristic and observed under the specified condition of an observation environment, and the luminance of a displayed image are brought in a linear relation.

7. The method of displaying a medical image as recited in claim 1, wherein the gradation of a medical image is transformed into such a gradation, by which the lightness of an image of a hard copy outputted under the condition of the specified output gradation characteristic and observed under the specified condition of an observation environment, and the lightness of a displayed image are brought in a linear relation.

8. The method of displaying a medical image as recited in claim 1, wherein the gradation of a medical image is transformed into such a gradation, by which the logarithmic values of the luminance of an image of a hard copy outputted under the condition of the specified output gradation characteristic and observed under the specified condition of an observation environment, and the logarithmic values of the luminance of a displayed image are brought in a linear relation.

9. The method of displaying a medical image as recited in claim 1, wherein the gradation of a medical image is transformed into such a gradation, by which the lightness of an image of a hard copy outputted under the condition of the specified output gradation characteristic and observed under the specified condition of an observation environment, and the lightness of a displayed image are made equivalent.

10. The method of displaying a medical image as recited in claim 1, wherein the gradation of a medical image is transformed into such a gradation, by which the lightness of an image of a hard copy outputted under the condition of the specified output gradation characteristic and observed under the specified condition of an observation environment, and the lightness of a displayed image are made equivalent, and further, in the case where a region of the gradation transformed by the transformation is irreproducible because of the effect of the minimum lightness value of a medical image display device, the gradation is corrected so that the irreproducible region is made to be reproduced.

11. The method of displaying a medical image as recited in claim 10, wherein the gradation of the medical image is transformed so that the irreproducible region is made to be reproduced by applying a smoothing operation to the characteristic curve of the medical image.

12. A medical image display apparatus comprising:
a gradation processor for processing image data of a medical image to transform the gradation of the medical image on the basis of the specified output gradation characteristic of an image outputting apparatus for outputting the medical image as a hard copy and the specified condition of an observation environment in which the hard copy is observed; and
an image display device for displaying the medical image based on the processed image data so that the medical image whose gradation has been transformed is displayed.

13. A medical image display apparatus comprising:
a memory device for memorizing at least one output gradation characteristic of an image outputting apparatus for outputting a medical image as a hard copy and at least one condition of an observation environment in which said hard copy is observed;
a gradation processor for processing image data of the medical image to transform the gradation of the medical image on the basis of a selected condition of an observation environment and a selected output gradation characteristic of the image outputting apparatus; and
an image display device for displaying the medical image based on the processed image data so that the medical image whose gradation has been transformed is displayed.

14. The medical image display apparatus of claim 13, wherein the memory device is connected to a medical image generating apparatus for generating a medical image through a network.

15. The medical image display apparatus of claim 12, wherein the gradation processor correlates the specified output gradation characteristic or the specified condition of an observation environment with a specified image outputting apparatus beforehand, and when the specified image outputting apparatus is used, the gradation processor applies the correlated specified output gradation characteristic or the correlated condition of an observation environment, as the basis of transforming the gradation of the medical image.

16. The medical image display apparatus of claim 12, wherein the gradation processor transforms the gradation of the medical image into such a gradation, by which the luminance of an image of a hard copy outputted under the condition of the specified output gradation characteristic and observed under the specified condition of an observation environment, and the luminance of a displayed image by the image display device are brought in a perceptually linear relation.

17. The medical image display apparatus of claim 12, wherein the gradation processor transforms the gradation of the medical image into such a gradation, by which the luminance of an image of a hard copy outputted under the condition of the specified output gradation characteristic and observed under the specified condition of an observation environment, and the luminance of a displayed image by the image display device are brought in a linear relation.

18. The medical image display apparatus of claim 12, wherein the gradation processor transforms the gradation of the medical image into such a gradation, by which the lightness of an image of a hard copy outputted under the condition of the specified output gradation characteristic and observed under the specified condition of an observation environment, and the lightness of a displayed image by the image display device are brought in a linear relation.

19. The medical image display apparatus of claim 12, wherein the gradation processor transforms the gradation of the medical image into such a gradation, by which the logarithmic values of the luminance of an image of a hard copy outputted under the condition of the specified output gradation characteristic and observed under the specified condition of an observation environment, and the logarithmic values of the luminance of a displayed image by the image display device are brought in a linear relation.

20. The medical image display apparatus of claim 12, wherein the gradation processor transforms the gradation of the medical image into such a gradation, by which the lightness of an image of a hard copy outputted under the condition of the specified output gradation characteristic and observed under the specified condition of an observation environment, and the lightness of a displayed image by the image display device are made equivalent.

21. The medical image display apparatus of claim 12, wherein the gradation processor transforms the gradation of the medical image into such a gradation, by which the lightness of an image of a hard copy outputted under the condition of the specified output gradation characteristic and observed under the specified condition of an observation environment, and the lightness of a displayed image are made equivalent, and further, in the case where a region of the gradation transformed by the transformation is irreproducible because of the effect of the minimum lightness value of a medical image display device, the gradation is corrected so that the irreproducible region is made to be reproduced.

22. The medical image display apparatus of claim 21, wherein the gradation processor transforms the gradation of the medical image so that the irreproducible region is made reproducible by applying a smoothing operation to the characteristic curve of the medical image.

23. A computer program for actualizing a method of displaying a medical image, wherein the method of displaying a medical image comprising the steps of:
processing image data of the medical image to transform the gradation of the medical image on the basis of the specified output gradation characteristic of an image outputting apparatus for outputting the medical image as a hard copy and the specified condition of an observation environment in which the hard copy is observed; and
displaying the medical image based on the processed image data so that the medical image whose gradation has been transformed is displayed.

24. A recording medium in which a computer program for actualizing a method of displaying a medical image is memorized, wherein the method of displaying a medical image comprising the steps of:
processing image data of the medical image to transform the gradation of the medical image on the basis of the specified output gradation characteristic of an image outputting apparatus for outputting the medical image as a hard copy and the specified condition of an observation environment in which the hard copy is observed; and
displaying the medical image based on the processed image data so that the medical image whose gradation has been transformed is displayed.
